(19) United States
(12) Patent Application Publication
(10) Pub. No.: US 2018/0061393 A1
(43) Pub. Date: Mar. 1, 2018

(54) SYSTEMS AND METHODS FOR ARTIFICAL INTELLIGENCE VOICE EVOLUTION

(71) Applicant: Microsoft Technology Licensing, LLC, Redmond, WA (US)

(72) Inventor: Neal Osotio, Sammamish, WA (US)

(73) Assignee: Microsoft Technology Licensing, LLC, Redmond, WA (US)

(21) Appl. No.: 15/245,615

(22) Filed: Aug. 24, 2016

(51) Int. Cl. G10L 13/033; G10L 25/63; G10L 15/18; G10L 13/04; G06N 99/00

(52) U.S. Cl. CPC G10L 13/0335; G10L 25/63; G06N 99/005; G10L 13/04; G10L 15/1815

(57) ABSTRACT

Systems and methods for evolving an AI voice are provided herein. More specifically, the systems and methods modify the pitch, duration, volume and/or timbre of an AI voice based on one or more user spoken language inputs and/or the evaluation of other known user data. Accordingly, the systems and methods as disclosed herein provide an AI voice that changes or evolves over time based on the user to increase engagement, trust, and/or emotional connection with the user without requiring any AI voice setting changes by the user.

### BACKGROUND

Language understanding systems, personal digital assistants, agents and artificial intelligence are changing the way users interact with the computers. Developers of computers, web services, and/or applications are always trying to improve the interactions between humans and computers. For example, developers may look for new ways to humanize artificial intelligence voice outputs.

It is with respect to these and other general considerations that aspects disclosed herein have been made. Also, although relatively specific problems may be discussed, it should be understood that the aspects should not be limited to solving the specific problems identified in the background or elsewhere in this disclosure.

### SUMMARY

In summary, the disclosure generally relates to systems and methods for evolving an AI voice. More specifically, the systems and methods disclosed herein modify the pitch, duration, volume and/or timbre of an AI voice based on one or more user inputs and/or the evaluation of other known user data. Accordingly, the systems and methods as disclosed herein provide an AI voice that evolves over time or changes based on the user to increase engagement, trust, and/or emotional connection with the user without requiring any AI voice setting changes by the user.

One aspect of the disclosure is directed to a system for evolved AI voice generation. The system includes at least one processor and a memory. The memory encodes computer executable instruction that, when executed by the at least one processor, are operative to:
provide a first AI voice with a first set of audio characteristics to output responses;
receive a user input via a microphone;
evaluate the user input to determine at least one of a user context and a user emotion;
determine a historical context based on the user input and previously received user inputs;
compare at least one of the user context, the user emotion, and the historical context to an evolution threshold;
determine that the evolution threshold has been met;
in response to the determination that the evolution threshold has been met, modify the first set of audio characteristics of the first AI voice to form a second AI voice with a second set of audio characteristics; and
in response to the determination that the evolution threshold has been met, utilize the second AI voice to output subsequent responses.

Another aspect of the disclosure is directed to a system an evolved AI voice generation. The system includes at least one processor and a memory. The memory encodes computer executable instruction that, when executed by the at least one processor, are operative to:
provide a first AI voice with a first set of audio characteristics to output client computing device responses;
receive a user spoken language input via a microphone on a client computing device;
evaluate the user spoken language input to form evaluation information; and
evolve the first set of audio characteristics of the first AI voice to form a second AI voice with a second set of audio characteristics based on the evaluation information.
   The audio characteristics include pitch, duration, and/or timbre. The first set of audio characteristics of the first AI voice is evolved to form the second AI voice with the second set of audio characteristics based on the evaluation information by:
providing an incremental change in at least one of the pitch, the duration, and the timbre to form the second set of audio characteristics; and
in response to the formation of the second AI voice, provide the second AI voice with the second set of audio characteristics to output subsequent client computing device responses.

Yet another aspect of the disclosure includes a method for evolved AI voice generation. The method includes:

providing a first AI voice with a first set of audio characteristics to output responses;

receiving a user spoken language input;

evaluating the user spoken language input to determine a user context and to determine a user emotion;

determining an environmental context based on accessible data;

determining a historical context based on the user spoken language input and previously received user spoken language inputs;

comparing the user context, the user emotion, the environmental context, and the historical context to an evolution threshold;

determining that the evolution threshold has been met;

in response to determining that the evolution threshold has been met, evolving the first set of audio characteristics of the first AI voice based on the user context, the user emotion, the environmental context, and the historical context to form a second set of audio characteristics; and

in response to determining that the evolution threshold has been met, providing a second AI voice with the second set of audio characteristics to output subsequent responses.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive embodiments are described with reference to the following Figures.

FIG. 1 is a schematic diagram illustrating a system for evolved AI voice generation, in accordance with aspects of the disclosure.

FIG. 2 is a schematic diagram illustrating a system for evolved AI voice generation, in accordance with aspects of the disclosure.

FIG. 3 is a schematic diagram illustrating a system for evolved AI voice generation, in accordance with aspects of the disclosure.

FIG. 4 is a flow diagram illustrating a method for evolved AI voice generation, in accordance with aspects of the disclosure.

FIG. 5 is a block diagram illustrating example physical components of a computing device with which various aspects of the disclosure may be practiced.

FIG. 6A is a simplified block diagram of a mobile computing device with which various aspects of the disclosure may be practiced.

FIG. 6B is a simplified block diagram of the mobile computing device shown in FIG. 10A with which various aspects of the disclosure may be practiced.

FIG. 7 is a simplified block diagram of a distributed computing system in which various aspects of the disclosure may be practiced.

FIG. 8 illustrates a tablet computing device with which various aspects of the disclosure may be practiced

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the spirit or scope of the present disclosure. The following detailed description is therefore not to be taken in a limiting sense, and the scope of the present disclosure is defined by the claims and their equivalents.

Progress in machine learning, language understanding and artificial intelligence are changing the way users interact with the computers. Digital assistant applications, such as Siri, Google Now and Cortana are examples of the shift in human computer interaction.

Currently, the artificial intelligent (AI) voices utilized for such applications include using pre-recorded variations of real humans speaking and having the user manually select which AI voice he or she would like as a verbal output from the platform. For example, the pre-recorded AI voice may be male versus female and have various inflections to introduce emotion and etc. However, due to the amount of time and resources required to create such pre-recorded AI voices, there are usually only a limited number of AI voice selections offered on a device. While previous systems and methods have adjusted the response based on user inputs, such as the phrasing, syntax, and dialect of the response, current systems and method do not adjust the actual sound of the AI voice itself. As such, there is currently no system or method for modifying or gradually evolving the sound of an AI voice dynamically in response to user inputs.

The systems and method as disclosed herein are directed to evolving the sound of an AI voice. More specifically, the systems and methods disclosed herein modify the pitch, duration, volume and/or timbre of an AI voice based on one or more user inputs and/or the evaluation of other known user data. Accordingly, the systems and methods as disclosed herein provide an AI voice that evolves over time or changes based on the user to increase engagement, trust, and/or emotional connection with the user without requiring any AI voice setting changes by the user.

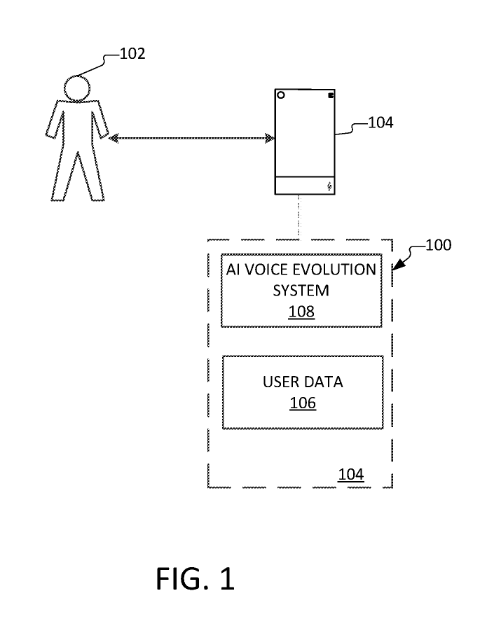

FIGS. 1-3 illustrate different examples of an AI voice system 100 being utilized by a user 102 via a client computing device 104, in accordance with aspects of the disclosure. The AI voice system 100 is any system that is capable of responding to a user input with voice output. The AI voice system 100 provides evolved AI voice generation. As such, the AI voice system 100 includes an AI voice evolution system 108.

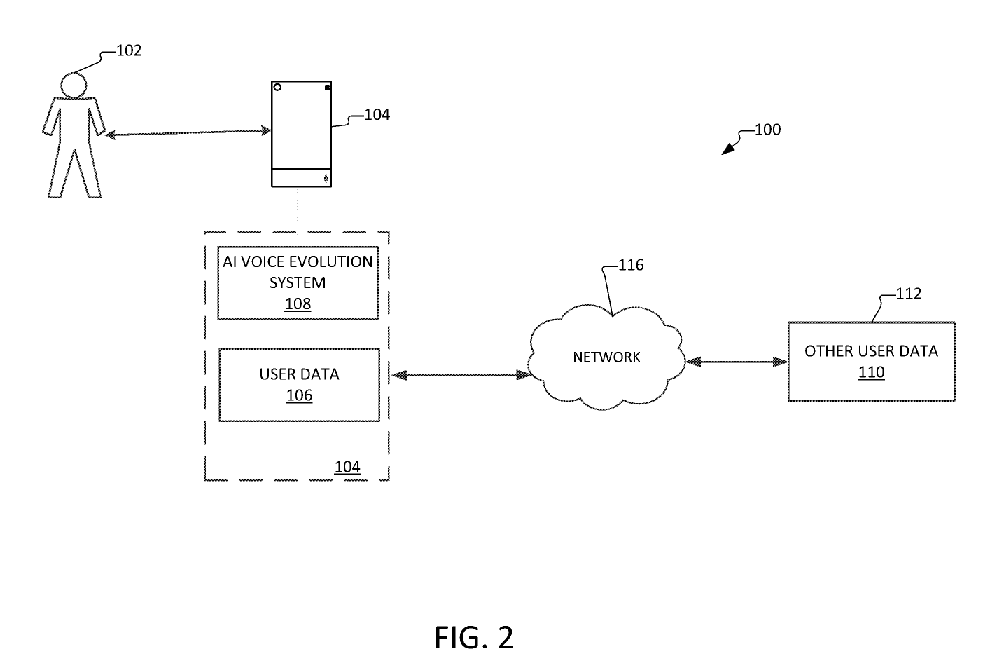

In some aspects, the AI voice system 100 is implemented on the client computing device 104 as illustrated in FIGS. 1-2. In a basic configuration, the client computing device 104 is a computer having both input elements and output elements. The client computing device 104 is configured to receive spoken language input and other modal input from a user 102. In some aspects, the client computing device 104 receives the spoken language input via a sensor on the client computing device 104, such as a microphone. The client computing device 104 may be any suitable computing device for implementing the AI voice system 100. For example, the client computing device 104 may be a mobile telephone, a smart phone, a tablet, a phablet, a smart watch, a wearable computer, a personal computer, a gaming system, a desktop computer, a laptop computer, an augmented reality device, a virtual reality device, smart speakers, and/or etc. This list is exemplary only and should not be considered as limiting. Any suitable client computing device 104 for implementing the AI voice system 100 may be utilized. The AI voice system 100 allows a user 102 to request actions via a spoken language input and other modal input from a user device 104

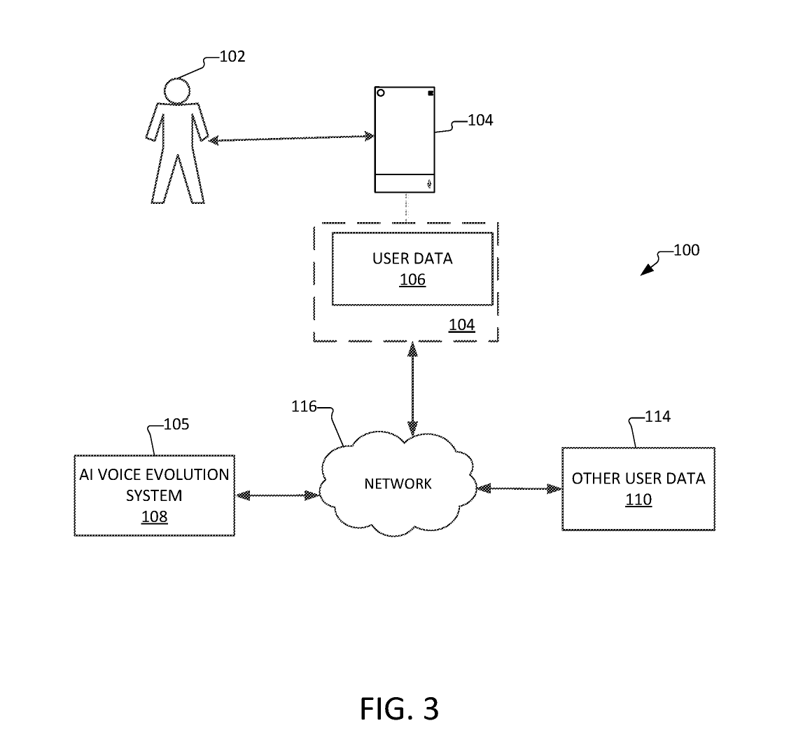

In other aspects, the AI voice system 100 is implemented on a server computing device 105, as illustrated in FIG. 3. The server computing device 105 may provide data to and/or receive data from the client computing device 104 through a network 116. In some aspects, the network 116 is a distributed computing network, such as the internet. In further aspects, that AI voice system 100 is implemented on more than one server computing device 105, such as a plurality or network of server computing devices 105. In some aspects, the AI voice system 100 is a hybrid system with portions of the AI voice system 100 on the client computing device 104 and with portions of the AI voice system 100 on the server computing device 105.

The AI voice evolution system 108 of the AI voice system 100 receives user input via the client computing device 104. The user input may be spoken language/voice input and/or any other form of user input, such as text, gesture, touch, handwritten, clicks, selection, faction expressions, eye tracking, and etc. The AI voice evolution system 108 evaluates the user input to determine a user context and/or a user emotion. As used herein, user context is any information relating to the user that helps to fully understand the user, such as user circumstances, user ideas, user conditions, user factors, user background, the current state of affairs of the user, and/or etc. For example, if the user input requests a list of nearby funeral homes, the AI voice evolution system 108 may be able to determine that context of the user is that the user is planning a funeral and that someone close to the user has passed away. As used herein, user emotion refers to the current emotional state of the user, such as happy, sad, angry, frustrated, excited, worried, and/or etc. For example, based on the same user input above and voice characteristics of the spoken language input of above, the AI voice evolution system 108 may be able to determine after evaluation that the user is sad and angry.

In some aspects, the AI voice evolution system 108 further evaluates other accessible user data or information in addition to the user input to determine user context and/or user emotion. The other accessible data is any data about the user that is accessible to the AI voice system 100. For example, accessible data may be user data 106 stored on the client computing device 104 or other user data 110 stored on a server 105, a knowledge backend 112, or on other client computing devices 114 of the user accessible to the AI voice evolution system 108 via the network 116. The accessible data may include user contextual information, user environmental information, and/or user historical information. For example, accessible data may include user calendar information, provided background information, credit history, search history from utilized search engines, ethnicity, citizenship, user hobbies, user employment, social media information, friends, family, education, hometown, weight, height, health, movie preferences, restaurant preferences, activity level, and/or etc. This list is exemplary only and is not meant to be limiting. In some aspects, AI voice system 100 and/or the client computing device 104 gathers the accessible user data from one or more other computing devices. For example, if the client computing device 104 is a gaming system, a natural user interface may interact with the user 102 and gather all of these modalities as user input. In further aspects, the client computing device 104 may run a plurality of apps, such as one or more email apps, social networking apps, global positioning system (GPS) apps, calendar apps, weather apps, etc. Interaction between the user 102 and the various apps operating on the client computing device 104 generate user data associated with the user that contains information in various subjects, which can be collected and analyzed. For example, user data generated by email messages sent and/or received via email apps, social network posts posted and/or read via social network apps, voice recognition of commands, searches submitted via search apps, web sites visited via browser apps, etc. may be evaluated to identify user context and/or user emotions.

In some aspects, the AI voice evolution system 108 utilizes a learning algorithm to determine the user context and/or the user emotion. In some aspects, the AI voice evolution system 108 utilizes the current user input and any other user inputs in the same thread to determine the user context and/or user emotion. Any known method for determine user context and/or user emotions for received user input may be utilized by the AI voice evolution system 108.

Additionally, in some aspects, the AI voice evolution system 108 of the AI voice system 100 evaluates the user input and/or the other accessible user data to determine a user environment. The user environment as used herein is information about the current environment of the user. For example, the user environment may include the GPS location of a user, the current time of day, the current weather, and/or etc. For example, client computing devices often have GPS location systems, clocks, and weather applications that may be utilized to determine the GPS location of a user, time of day, and the weather for the given GPS location for the user.

Further, in additional aspects, the AI voice evolution system 108 of the AI voice system 100 evaluates the user input and/or accessible data to update historical information about the user. The historical information may also include past determined user emotions and/or user contexts. Further, in some aspects, the user historical information may include past user environments. The historical information may include any past or historical information about the user. For example, the historical information may include historic user contexts such as the user returned from a vacation two weeks ago or bought a new car last month. In another example, the historical information may include emotional trends or history, such as the user often gets angry after a meeting with a certain colleague or historical emotional information, such as the user is often excited when watching sporting events.

Once the AI voice evolution system 108 has determined a user context, a user emotion and/or the user historical information, the AI voice evolution system 108 compares the user context, the user emotion and/or the user historical information to an evolution threshold. In some aspects, the AI voice evolution system 108 also compares the determined user environment to the evolution threshold. In some aspects the evolution threshold includes an environmental threshold, a contextual threshold, a historical threshold, and/or an emotional threshold. In some embodiments, the evolution threshold is a weighted combination of contextual information, emotional information, and environmental informational and/or historical information. However, any suitable threshold for determining that a change in the AI voice would be appropriate for the user based on the determined user context, user emotion, user environment, and/or user historical information may be utilized by the AI voice evolution system. If the AI voice evolution system 108 determines that the evolution threshold has not been breached, the AI voice evolution system 108 provides the previously utilized AI voice to the AI voice system 100 for outputting a response.

If the AI voice evolution system 108 determines that the evolution threshold has been breached, the AI voice evolution system 108 evolves or modifies the sound of the currently utilized AI voice based on the user context, user emotion, user historical information, and/or user environment. The sound of the AI voice is based on one or more of the following audio characteristics: duration, pitch, volume, and timbre. As such, the AI voice evolution system 108 evolves or modifies the duration, pitch, volume and/or timbre of the AI voice based on the user context, user emotion, user historical information, and/or user environment. As used herein, the pitch of the AI voice indicates how high or low the sound is of the AI voice. The duration indicates how long or short each syllable of the sound is of the AI voice. The volume indicates how loud or soft the sound is of the AI voice. The timbre indicates the quality and/or origin (the pre-conscious allocation of a sonic identity of a sound) of the sound of the AI voice.

In some aspects, the AI voice evolution system 108 provides incremental changes in the duration, pitch, volume and/or timbre of the AI voice, so the change in the AI voice is not readily apparent to the user. For example, if based on the received spoken language inputs of the user, the user is determine to prefer to converse with an older and wiser individual, the AI voice may be gradually changed or evolved over time until the AI voice sounds older and wiser. In these aspects, the AI voice changes over time slowly based on the user. For example, the AI voice may modified to slowly age along with the user, however each changed made to the voice to slowly age is not readily noticeable by the user. In other embodiments, the AI voice evolution system 108 provides a noticeable change in the duration, pitch, volume and/or timbre of the AI voice, so the change in the AI voice readily reflects or responds to a determined user emotion or user context. For example, if based on the received spoken language input, the user is determined to be excited and in a hurry, the AI voice may be modified to respond with a noticeable faster duration and higher volume to match the received spoken language input of the user. In another example, if based on the user input, it is determine that the user is angry, the audio characteristic may be noticeably changed to provide a more soothing AI voice. In these aspects, the AI voice changes instantly and noticeably based on the user context and user emotion. Once the AI voice has been modified, the modified or evolved AI voice is provided to the AI voice system 100 to respond to the user input.

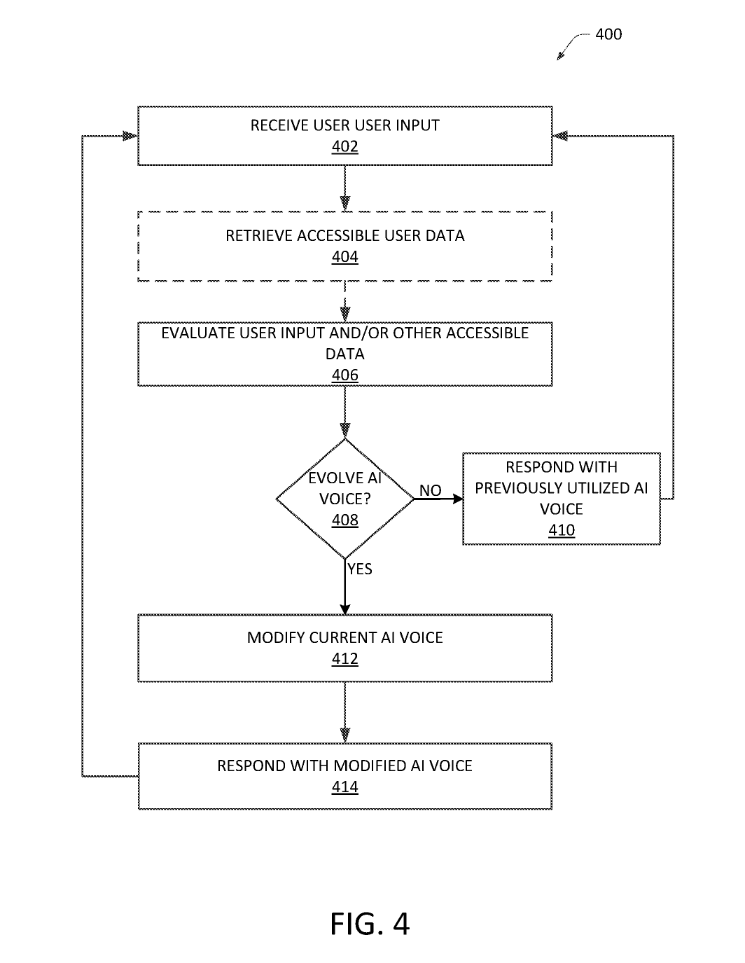

FIG. 4 illustrates a flow diagram conceptually illustrating an example of a method 400 for evolved AI voice generation. In some aspects, method 400 is performed by the AI voice system 100 as described above. Method 400 provides a method for modifying the pitch, duration, volume and/or timbre of an AI voice based on one or more user spoken language inputs and/or the evaluation of other known user data. Accordingly, method 400 provides an AI voice that evolves over time or changes based on the user to increase engagement, trust, and/or emotional connection with the user without requiring any AI voice setting changes by the user.

Method 400 includes operation 402. At operation 402, a user input is received. In some aspects, the user input is a spoken language input. In other aspects, the user input is a text, touch, or form user input. In further aspects, the user input is received via a client computing device at operation 402. For example, the client computing device may receive a spoken language input via a sensor, such as a microphone, on the client computing device.

In some aspects, method 400 includes operation 404. At operation 404, accessible user data is retrieved. The accessible user data may include data about the user stored on a current client computing device or user data accessed over a network from another computing device or application, such as user's search history, calendar, background, and etc. In some aspects, the accessible user data includes retrieving historical data about the user. For example, the user accessible data may retrieved from a server computing device, a client computing device, a web browser, a calendaring application, a database, and/or etc.

At operation 406, the user input is evaluated to form evaluation information. In some embodiments, the user input is evaluated along with the retrieved user data to form the evaluation information. The user input and/or the user data may be evaluated to determine a user context, a user emotion, and/or user historical data. In some aspects, the user input and/or the user data may be evaluated to determine a user environment. As such, the evaluation information may include a user context, a user emotion, a user historical information and/or a user environment.

After operation 406, operation 408 is performed. At operation 408, a determination of whether or not to evolve a previously provided AI voice with a set of audio characteristics is made. In some aspects, at operation 408, the evaluation information, such as the user context, user environment, user emotion, and/or the user historical data, is compared to an evolution threshold. If the evaluation information does not meet the evolution threshold based on the comparison at operation 408, operation 410 is performed. If the evaluation information meets the evolution threshold based on the comparison at operation 408, operation 412 is performed.

At operation 410, the previously utilized AI voice with a set of audio characteristics is provided to respond to the user input. As such, the AI voice provided at operation 410 is the same as the previously provided AI voice that was utilize to respond to the last user input.

At operation 412, the previously utilized AI voice is modified to form a modified AI voice. At operation 412 the audio characteristic of the previously utilized AI voice are modified or evolved based on the evaluation information, such as the user context, user environment, user emotion, and/or the user historical data to form the modified AI voice. As discussed above, the audio characteristics include pitch, volume, timbre, and/or duration. In some aspects, an incremental change to the pitch, volume, timbre, and/or duration is provided at operation 412 to form a modified or evolved AI voice. The incremental change in the new AI voice should not be readily noticeable by the user. In other aspects, a noticeable change in the duration, pitch, volume and/or timbre of the AI voice is provided at operation 412, so the change in the AI voice is noticeable to the user and may readily reflect or respond to a determined user emotion or user context.

After operation 412, the modified or evolved AI voice is provided to respond to the user input at operation 414. The modified AI voice utilized or provided at operation 414 is based on or utilizes the modified audio characteristics formed during operation 412.

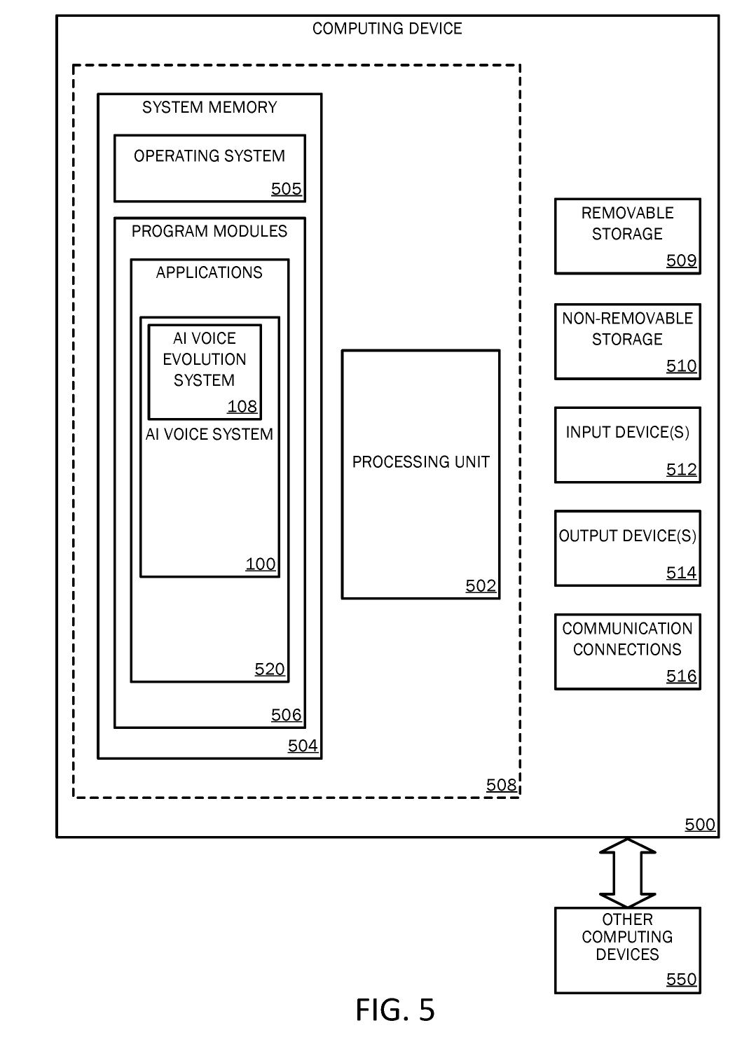

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. For example, the AI voice evolution system 108 of the AI voice system 100 could be implemented by the computing device 500. In some aspects, the computing device 500 is a mobile telephone, a smart phone, a tablet, a phablet, a smart watch, a wearable computer, a personal computer, a desktop computer, a gaming system, a laptop computer, an augmented reality device, a virtual reality device, smart speakers, and/or etc. The computing device components described below may include computer executable instructions for AI voice evolution system 108 and/or the AI voice system 100 that can be executed to employ method 400 generate an evolved or modified AI voice as disclosed herein. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combined of such memories. The system memory 504 may include an operating system 505 and one or more program modules 506 suitable for running software applications 520. The operating system 505, for example, may be suitable for controlling the operation of the computing device 500. Furthermore, aspects of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510. For example, user data, user contexts, user emotions, user environments, and/or user historical data of the AI voice system 100 and/or AI voice evolution system 108 could be stored on any of the illustrated storage devices.

As stated above, a number of program modules and data files may be stored in the system memory 504. While executing on the processing unit 502, the program modules 506 (e.g., the AI voice system 100, AI voice evolution system 108) may perform processes including, but not limited to, performing method 400 as described herein. For example, the processing unit 502 may implement the AI voice evolution system 108 and/or the AI voice system 100. Other program modules that may be used in accordance with aspects of the present disclosure, and in particular to generate screen content, may include a digital assistant application, a voice recognition application, an email application, a social networking application, a collaboration application, an enterprise management application, a messaging application, a word processing application, a spreadsheet application, a database application, a presentation application, a contacts application, a gaming application, an e-commerce application, an e-business application, a transactional application, exchange application, a device control application, a web interface application, a calendaring application, etc. In some aspect, the AI voice system 100 allows a user to interact with one or more of the above referenced applications through spoken language inputs and/or spoken language outputs.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip).

Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 500 may also have one or more input device(s) 512 such as a keyboard, a mouse, a pen, a microphone or other sound or spoken language input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, RF transmitter, receiver, and/or transceiver circuitry, universal serial bus (USB), parallel, and/or serial ports.

The term computer readable media or storage media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

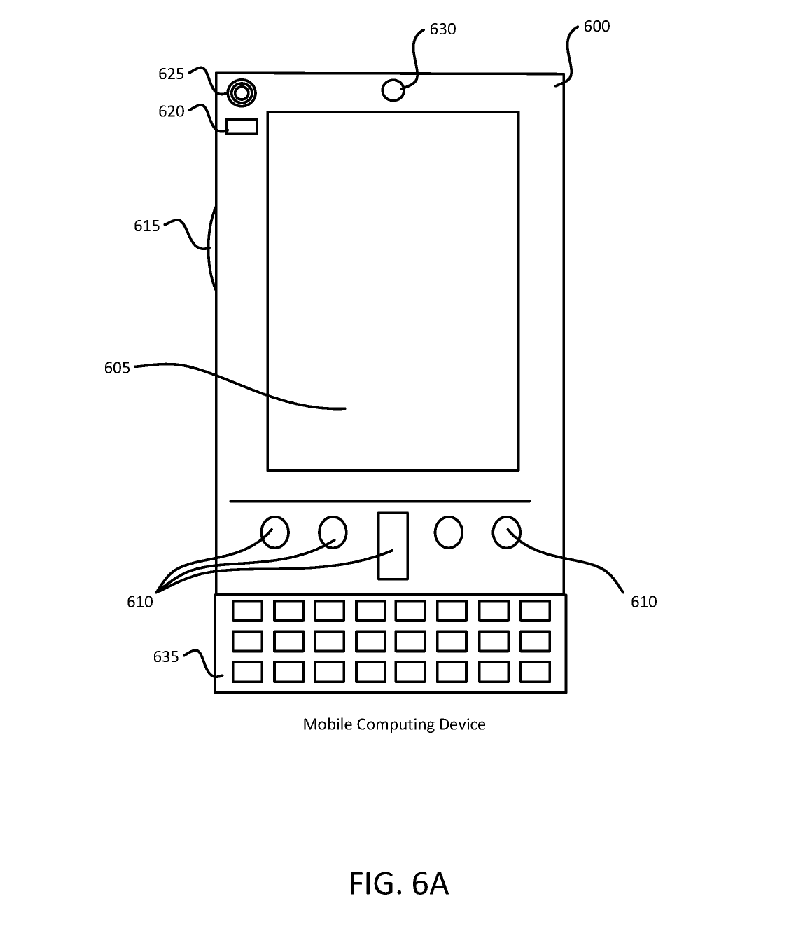

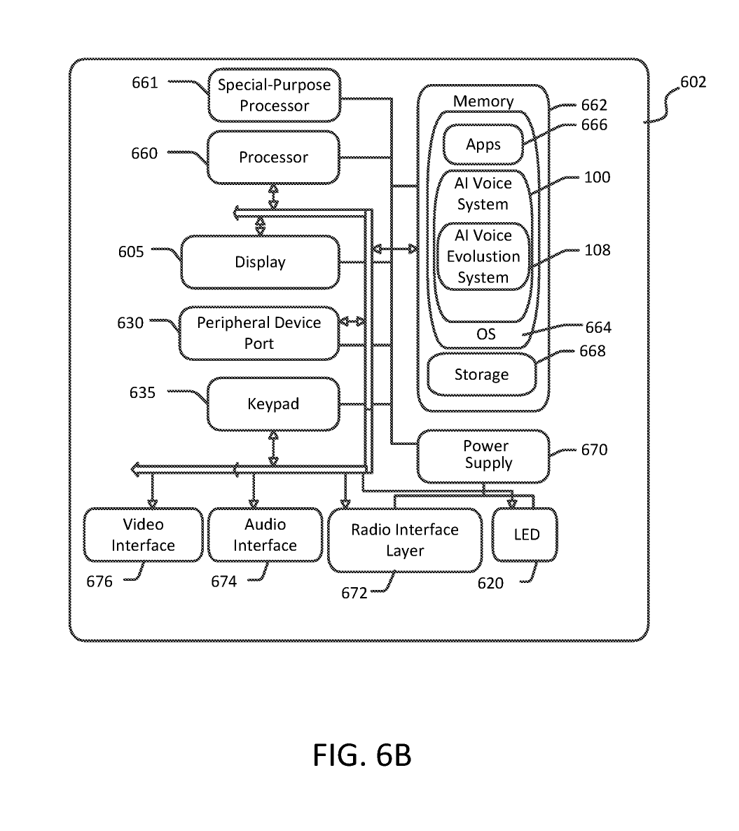

FIGS. 6A and 6B illustrate a mobile computing device 600, for example, a mobile telephone, a smart phone, a tablet, a phablet, a smart watch, a wearable computer, a personal computer, a desktop computer, a gaming system, a laptop computer, an augmented reality device, a virtual reality system, smart speakers, or the like, with which aspects of the disclosure may be practiced. With reference to FIG. 6A, one aspect of a mobile computing device 600 suitable for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display).

If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some aspects. In yet another alternative aspect, the mobile computing device 600 is a portable phone system, such as a cellular phone. The mobile computing device 600 may also include an optional keypad 635. Optional keypad 635 may be a physical keypad or a “soft” keypad generated on the touch screen display.

In addition to, or in place of a touch screen input device associated with the display 605 and/or the keypad 635, a Natural User Interface (NUI) may be incorporated in the mobile computing device 600. As used herein, a NUI includes as any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence.

In various aspects, the output elements include the display 605 for showing a graphical user interface (GUI). In aspects disclosed herein, the various user information collections could be displayed on the display 605. Further output elements may include a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one aspect, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 and/or the AI voice system 100 run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

The system 602 has a power supply 670, which may be implemented as one or more batteries. The power supply 670 might further include an external power source, such as an AC adapter or a powered docking cradle that supplements or recharges the batteries.

The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated aspect, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

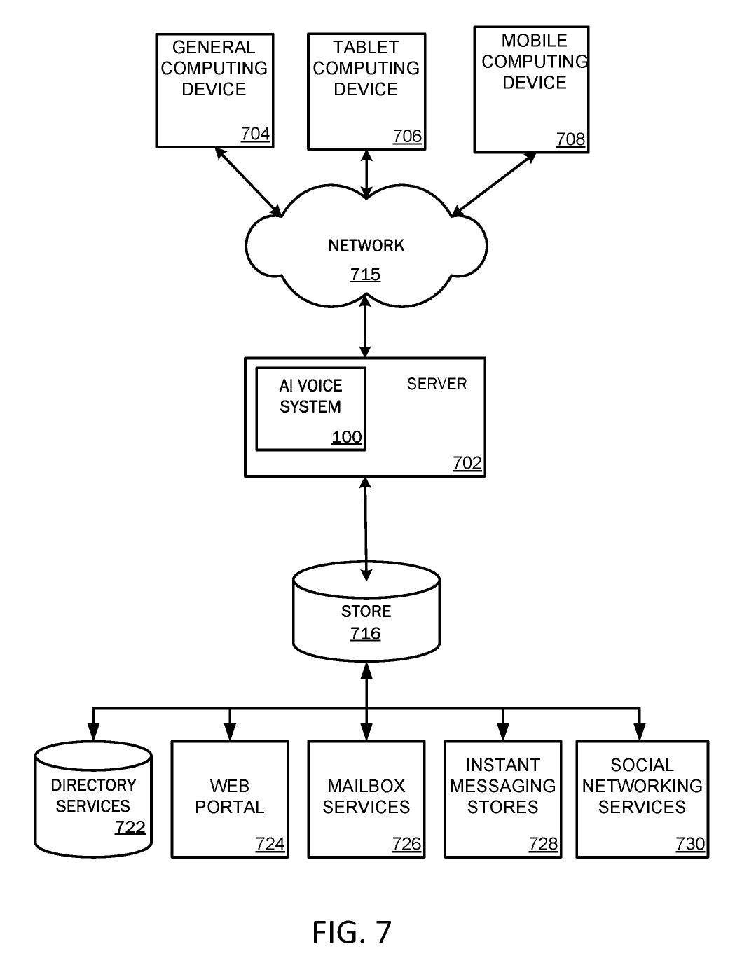

FIG. 7 illustrates one aspect of the architecture of a system for processing data received at a computing system from a remote source, such as a general computing device 704, tablet 706, or mobile device 708, as described above. Content displayed and/or utilized at server device 702 may be stored in different communication channels or other storage types. For example, various documents may be stored using a directory service 722, a web portal 724, a mailbox service 726, an instant messaging store 728, and/or a social networking site 730. By way of example, the AI voice evolution system 108 and/or the AI voice system 100 may be implemented in a general computing device 704 (e.g. a gaming system, a virtual reality system, a desktop computer, or other smart non-mobile device), a tablet computing device 706 and/or a mobile computing device 708 (e.g., a smart phone, a smart watch, or other smart mobile devices). In some aspects, the server 702 is configured to implement an AI voice system 100 and/or an AI voice evolution system 108, via the network 715 as illustrated in FIG. 7.

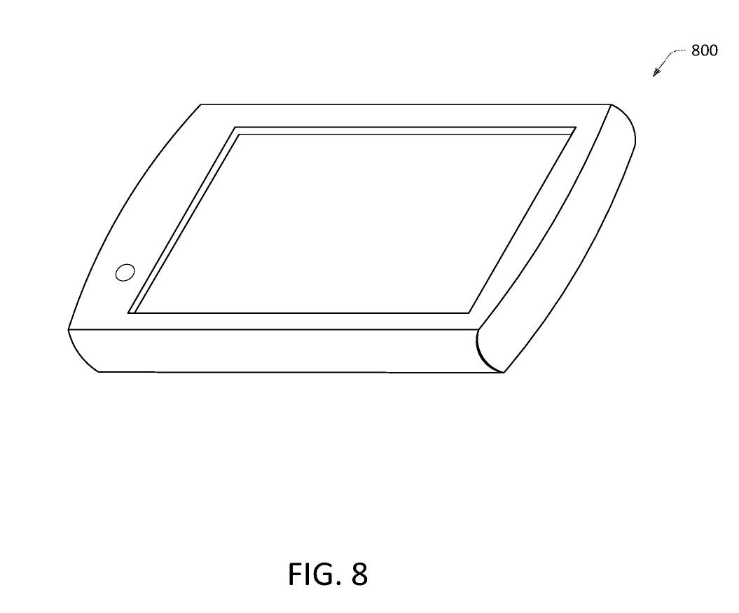

FIG. 8 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Embodiments of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

This disclosure described some embodiments of the present technology with reference to the accompanying drawings, in which only some of the possible aspects were described. Other aspects can, however, be embodied in many different forms and the specific embodiments disclosed herein should not be construed as limited to the various aspects of the disclosure set forth herein. Rather, these exemplary aspects were provided so that this disclosure was thorough and complete and fully conveyed the scope of the other possible aspects to those skilled in the art. For example, aspects of the various embodiments disclosed herein may be modified and/or combined without departing from the scope of this disclosure.

Although specific aspects were described herein, the scope of the technology is not limited to those specific aspects. One skilled in the art will recognize other aspects or improvements that are within the scope and spirit of the present technology. Therefore, the specific structure, acts, or media are disclosed only as illustrative aspects. The scope of the technology is defined by the following claims and any equivalents therein.

1. A system for evolved artificial intelligence (AI) voice generation, the system comprising:
at least one processor; and
a memory for storing and encoding computer executable instructions that, when executed by the at least one processor is operative to:
provide a first AI voice with a first set of audio characteristics to output responses;
receive a user input via a microphone;
evaluate the user input to determine at least one of a user context and a user emotion;
determine a historical context based on the user input and previously received user inputs;
compare at least one of the user context, the user emotion, and the historical context to an evolution threshold;
determine that the evolution threshold has been met;
in response to the determination that the evolution threshold has been met, modify the first set of audio characteristics of the first AI voice to form a second AI voice with a second set of audio characteristics; and
in response to the determination that the evolution threshold has been met, utilize the second AI voice to output subsequent responses.

2. The system of claim 1, wherein the audio characteristics include pitch, duration, volume, and timbre.

3. The system of claim 2, wherein evolve the first set of audio characteristics of the first AI voice to form the second AI voice with the second set of audio characteristics comprises:
an incremental change in the pitch.

4. The system of claim 2, wherein evolve the first set of audio characteristics of the first AI voice to form the second AI voice with the second set of audio characteristics comprises:
an incremental change in the duration.

5. The system of claim 2, wherein evolve the first set of audio characteristics of the first AI voice to form the second AI voice with the second set of audio characteristics comprises:
an incremental change in the timbre.

6. The system of claim 2, wherein evolve the first set of audio characteristics of the first AI voice to form the second AI voice with the second set of audio characteristics comprises:
an incremental change in the pitch and the timbre.

7. The system of claim 1, wherein the evolution threshold comprises at least one of an emotional threshold, a contextual threshold, and a historical threshold.

8. The system of claim 1, wherein the at least one processor is operative to:
retrieve accessible user data from one or more sources,
wherein the user context and the user emotion is also based on the accessible user data.

9. The system of claim 1, wherein the system is a client computing device.

10. The system of claim 9, wherein the client computing device is at least one of:
a smart phone;
a tablet;
a smart watch;
a wearable computer;
a virtual reality system;
a smart speaker;
a personal computer;
a desktop computer;
a gaming system; and
a laptop computer.

11. A system for an evolved AI voice generation, the system comprising:
at least one processor; and
a memory for storing and encoding computer executable instructions that, when executed by the at least one processor is operative to:
provide a first AI voice with a first set of audio characteristics to output client computing device responses,
wherein the audio characteristics include pitch, duration, and timbre;
receive a user spoken language input via a microphone on a client computing device;
evaluate the user spoken language input to form evaluation information;
evolve the first set of audio characteristics of the first AI voice to form a second AI voice with a second set of audio characteristics based on the evaluation information,
wherein evolve the first set of audio characteristics of the first AI voice to form the second AI voice with the second set of audio characteristics based on the evaluation information comprises:
providing an incremental change in at least one of the pitch, the duration, and the timbre to form the second set of audio characteristics; and
in response to the formation of the second AI voice, provide the second AI voice with the second set of audio characteristics to output subsequent client computing device responses.

12. The system of claim 11, wherein the audio characteristics also include volume.

13. The system of claim 12, wherein the second AI voice sounds older than the first AI voice.

14. The system of claim 11, wherein the evaluation information includes at least one of user context, user emotion, and user historical context.

15. A method for evolved AI voice generation, the method comprising:
providing a first AI voice with a first set of audio characteristics to output responses;
receiving a user spoken language input;
evaluating the user spoken language input to determine a user context and to determine a user emotion;
determining an environmental context based on accessible data;
determining a historical context based on the user spoken language input and previously received user spoken language inputs;
comparing the user context, the user emotion, the environmental context, and the historical context to an evolution threshold;
determining that the evolution threshold has been met;
in response to determining that the evolution threshold has been met, evolving the first set of audio characteristics of the first AI voice based on the user context, the user emotion, the environmental context, and the historical context to form a second set of audio characteristics; and
in response to determining that the evolution threshold has been met, providing a second AI voice with the second set of audio characteristics to output subsequent responses.

16. The method of claim 15, wherein the audio characteristics include pitch, duration, volume, and timbre.

17. The method of claim 16, wherein evolving the first set of audio characteristics of the first AI voice based on the user context, the user emotion, the environmental context, and the historical context to form the second set of audio characteristics and the second AI voice comprises:
an incremental change in at least one of the pitch, the duration, the volume, and the timbre.

18. The method of claim 17, wherein the incremental change makes the second AI voice sounds more nurturing.

19. The method of claim 15, wherein the evolution threshold comprises at least one of an environmental threshold, an emotional threshold, a contextual threshold, and a historical threshold.

20. The method of claim 15, further comprising:
retrieving accessible user data from a plurality of sources;
wherein the user context and the user emotion is also based on the accessible user data, and
wherein the accessible user data is information stored on a client computing device and a server accessible over a network.
